(19) United States
(12) Patent Application Publication
(10) Pub. No.: US 2002/0059631 A1
(43) Pub. Date: May 16, 2002

(54) Digital TV system for setting viewer-environments using network and control method thereof

(75) Inventor: Sang Sun Lee, Kumi-si (KR)

Correspondence Address: FLESHNER & KIM, LLP, P.O. Box 221200, Chantilly, VA, 20153-1200, US

(73) Assignee: LG Electronics, Inc.

(21) Appl. No.: 09/930,441

(22) Filed: Aug. 16, 2001

(30) Foreign Application Priority Data
Aug. 18, 2000 (KR) 47896/2000

(51) Int. Cl. G06F 3/00

(52) U.S. Cl. 725/108

(57) ABSTRACT

A digital TV system for setting viewer-environments using a network and a control method thereof is disclosed. The system and a control method thereof can automatically set the TV into environments suitable for a viewer's taste by storing environmental information set by the viewer into a server and freely downloading the stored environmental information from the server. The method for setting environment corresponding to a viewer's taste in a digital TV system including a TV connected with a server and a network includes the steps of: transmitting environmental information selected by the viewer to the server using an initial menu from the TV to the server; storing the environmental information into the server to correspond to the viewer's taste; transmitting a download request of environmental information inputted by the viewer from the TV to the server; transmitting the environmental information corresponding to the download request from the server to the TV; and executing the environmental information downloaded from the TV. The present invention can provide the viewer with convenience by allowing the viewer to store TV environments suitable for the viewer's taste in the server or download from the server to set desired TV environments.

### BACKGROUND OF THE INVENTION

1. Field of the Invention

The present invention relates to a digital TV, and more particularly, to a digital TV system for setting viewer-environments using a network and a control method thereof, which can automatically set the TV into environments desired by a viewer's by storing environmental information set by the viewer into a server and freely downloading the stored environmental information from the server.

2. Background of the Related Art

In general, a digital TV is a device that adds a function capable of receiving digital broadcasting signal to an analog TV, i.e., a system that receives and displays signal transmitted from an antenna of public wave broadcasting or cable broadcasting.

However, in the near future, the digital TV will be connected to a network, receive various information such as image, sound and data through an Internet and provide viewers with information.

Moreover, till now, the TV has only a receiving function. However, in the future, the TV will have also a function of transmitting viewers' information to broadcasting stations or various Internet servers.

Meanwhile, environments set by the viewers using the TV may differ according to individual preference. That is, because signal channel structure, image/sound data, broadcasting reservation information, time setting and broadcasting guide setting set according to the individual preference are different from one another, each viewer wants to set environments suitable for the viewer's taste.

As previously described, because being complex in changing the setting of environments, the conventional digital TV provides the viewers with inconvenience in setting environments suitable for each viewer's taste.

### SUMMARY OF THE INVENTION

Accordingly, the present invention is directed to a digital TV system for setting viewer-environments using a network and a control method thereof that substantially obviates one or more problems due to limitations and disadvantages of the related art.

An object of the present invention is to provide a digital TV system for setting viewer-environments using a network and a control method thereof, which can set TV environments using a network.

Another object of the present invention is to provide a digital TV system for setting viewer-environments using a network and a control method thereof, which can set environments for watching TV with a simple manipulation and store the environments into a server.

A further object of the present invention is to provide a digital TV system for setting viewer-environments using a network and a control method thereof, which can automatically set the TV environments by downloading environmental information stored in the server according to the viewer's request.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a method for setting environment corresponding to a viewer's taste in a digital TV system includes the steps of: transmitting environmental information selected by the viewer to a server using an initial menu from the TV to the server; storing the environmental information into the server to correspond to the viewer's taste; transmitting a download request of environmental information inputted by the viewer from the TV; transmitting the environmental information corresponding to the download request from the server to the TV; and executing the environmental information downloaded from the TV.

According to the method for setting environments suitable for the viewer's taste, when the environmental information is transmitted from the TV to the server, the environmental information includes TV address, server address, ID number and viewer selection environmental information. When the download request of environmental information is transmitted from the TV to the server, the download request includes TV address, server address, ID number and download request code.

Before the step of transmitting the environmental information to the server, the method for setting environments suitable for the viewer's taste further includes the steps of outputting the initial menu in response to the viewer's request of environment setting from the TV, and determining whether or not the viewer is registered based on the ID number included in the environmental information received from the TV.

According to the method for setting environments suitable for the viewer's taste, the step of transmitting the environmental information from the server to the TV includes the steps of: determining whether or not the viewer is registered based on the ID number included in the download request received from the TV; and inquiring whether or not there is environmental information corresponding to the ID number.

According to the method for setting environments suitable for the viewer's taste, the downloaded environmental information is changed into the viewer's environments through an environment change program.

According to another preferred embodiment of the present invention, a method for controlling a viewer's environment setting includes the steps of: outputting initial menu in response to the viewer's request of environment setting; transmitting a download request of environmental information inputted by the viewer to the server based on the initial menu; receiving environmental information corresponding to the download request from the server; and changing the former environments into environments suitable for the viewer's taste based on the downloaded environmental information, wherein the environmental information is inquired from the server based on the viewer's ID number.

Before the step of transmitting the download request of environmental information to the server, the method for controlling a viewer's environment setting further includes the step of transmitting the environmental information selected by the viewer using the initial menu, wherein the environmental information is stored in the server corresponding to the viewer's ID number.

According to still another preferred embodiment of the present invention, a method for providing a viewer's environments includes the steps of: receiving environmental information selected by the viewer; storing the environmental information corresponding to the viewer's ID number; receiving a download request of environmental information inputted by the viewer from the TV; inquiring whether or not there is the viewer's environmental information based on the ID number included in the download request; reading the environmental information corresponding to the ID number when the viewer's environmental information is inquired; and transmitting the read environmental information to the TV.

According to the method for providing a viewer's environments, a digital TV system includes: a server for storing environmental information selected by the viewer, the server providing the environmental information when the viewer requests download; a network for connecting to the server; a controller for reading the initial menu from the memory for allowing the viewer to select the environmental information, providing to a screen, transmitting the environmental information to the server, the controller transmitting the download request to the server when the viewer requests download of the environmental information and executing the environmental information downloaded from the server and changing the former environments into environments suitable for the viewer's taste; and a memory for storing a menu for setting the environments, a program for executing the environmental information and the viewer's changed environments.

According to the digital TV system for setting viewer's environments using the network, the memory includes at least one of an EEPROM, a flash ROM and an HDD.

According to the digital TV system for setting viewer's environments using the network, the server includes: a viewer confirmation part for confirming whether or not the viewer is registered; a viewer request determining part for determining the request received from the controller if the viewer is registered; a database inquiry part for inquiring the viewer's environmental information based on the ID number if the request is the download request of environmental information; and a database for storing the environmental information selected by the viewer to correspond to the ID number.

According to a further preferred embodiment of the present invention, a digital TV device includes: input means for inputting a viewer's environmental information; display means for providing the viewer with initial menu for selecting the environmental information; network connecting means for transmitting the environmental information to the server through the network and downloading the environmental information from the server; storing means for storing the initial menu, environment change program and changed environmental information; and controlling means for reading the initial menu from the memory, outputting the same to the display means, receiving the environmental information or a download request from the input means and outputting the same to the network connecting means, the controlling means executing the environment change program and controlling to change the former environments into the viewer's environments if the environmental information is inputted from the network connecting means through the network.

According to a still further preferred embodiment of the present invention, a server system includes: a memory for storing database and program; and a processor connected to the memory and executing the program, wherein the processor performs, by the program, the steps of: receiving environmental information selected by a viewer; storing the environmental information corresponding to the viewer's ID number; receiving a download request of environmental information inputted by the viewer; inquiring whether or not there is the viewer's environmental information based on the ID number included in the download request; reading the environmental information corresponding to the ID number if the viewer's environmental information is inquired; and transmitting the read environmental information to a TV.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings;

FIG. 1 illustrates a brief view of a digital TV system for setting viewer-environments using a network according to a preferred embodiment of the present invention;

FIG.2 illustrates a detail view of the digital TV system for setting viewer-environments using the network shown in FIG. 1;

FIG.3 illustrates a flow chart of a control method of the digital TV system for setting viewer-environments using the network according to the preferred embodiment of the present invention;

FIG.4 illustrates a flow chart of a display method of an initial menu, in the digital TV system for setting viewer-environments using the network according to the preferred embodiment;

FIG. 5 illustrates a flow chart of a method for storing environmental information selected by a viewer, in the digital TV system for setting viewer-environments using the network according to the preferred embodiment;

FIG. 6 illustrates a flow chart of a method for setting TV environments using environmental information stored in a server, in the digital TV system for setting viewer-environments using the network according to the preferred embodiment;

FIGS. 7a to 7d illustrate exemplary views of the screen displaying a state that environmental information selected by the viewer is stored in the server, in the digital TV system for setting viewer-environments using the network according to the preferred embodiment; and

FIGS. 8a to 8d illustrate exemplary views of the screen for setting environmental information stored in the server, in the digital TV system for setting viewer-environments using the network according to the preferred embodiment.

### DETAILED DESCRIPTION OF THE PREFERRED EMBODIMENT

Reference will now be made in detail to the preferred embodiments of the present invention, examples of which are illustrated in the accompanying drawings.

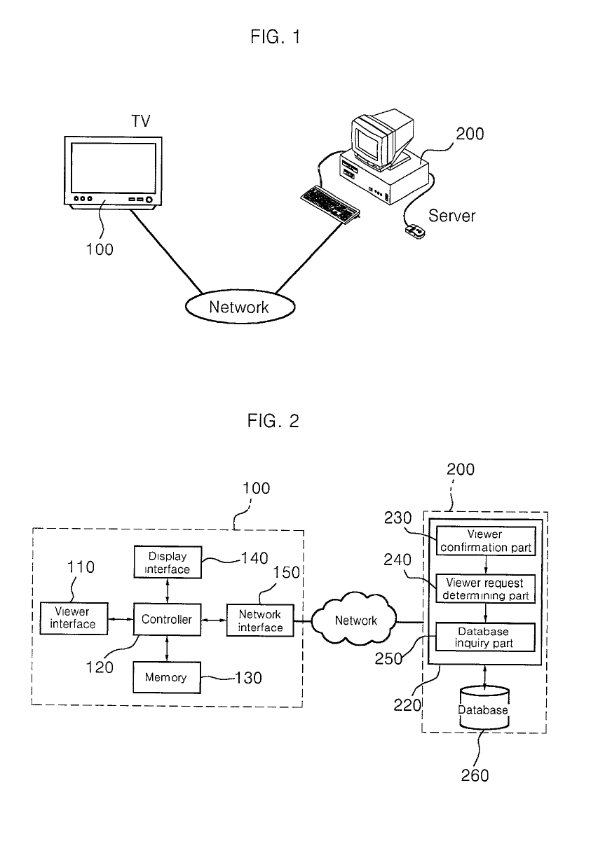

FIG.1 illustrates a brief view of a digital TV system for setting viewer-environments using a network according to a preferred embodiment of the present invention, and FIG.2 illustrates a detail view of the digital TV system of FIG. 1.

Referring to FIGS. 1 and 2, the digital TV system provides a viewer with an initial menu for setting environments. The digital TV system includes a TV 100 for receiving environmental information selected by the viewer and transmitting the same to a server 200, and the server 200 for receiving and storing the environmental information from the TV 100 and providing the environmental information if there is the viewer's request.

The digital TV system may further include a network connected between the TV 100 and the server 200 for transmitting the environmental information of the TV to the server 200 and for allowing the viewer to download the environmental information from the server 200.

The TV 100 includes a viewer interface 110, a controller 120, a memory 130, a display interface 140 and a network interface 150.

The viewer interface 110 receives a display request of initial menu of the viewer, a download request of environmental information or a selection order of environmental information and transmits the same to the controller 120. Here, the viewer interface 110 can perform various requests or demands related to environment setting to the TV 100 using an input device or a remote controller. It is preferable that the input device includes a keyboard, a keypad and a touch screen.

The controller 120 receives the display request of the initial menu from the viewer, transmits initial menu stored in the memory 130 to the display interface 140, receives the environmental information selected to be suitable for the viewer's taste using the initial menu and transmits to the server 200. The controller 120 transmits a stored state of the environmental information to the display interface 140 while the environmental information is stored in the server 200. The controller 120 can change environments of the TV 100 into environments selected according to the viewer's taste by receiving the download request of environmental information, requesting the environmental information to the server 200 and executing the environmental information transmitted from the server 200. At this time, the controller 120 transmits a receiving state of the environmental information downloaded from the server 200 to the display interface 140.

The memory 130 can store initial menu, environmental information selection list, environment change program, etc. Here, the memory 130 may include an EEPROM, a flash ROM or an HDD. Therefore, the memory 130 selects the initial menu and the environmental information selection list through control of the controller 120 and transmits the same to the display interface 140. After that, the memory 130 changes environments of the TV 100 into environments suitable for the viewer's taste by means of the environment change program when the environmental information is downloaded.

The display interface 140 can output the initial menu and the environmental information selection list transmitted from the controller 120. Here, the screen includes a liquid crystal display (LCD) panel capable of displaying image or characters, a plasma display panel (PDP), a cathode ray tube (CRT) or a projection display panel.

The network interface 150 transmits the environmental information selected by the viewer to the server 200 through the network and downloads the viewer's environmental information from the server 200.

Meanwhile, the server 200 may include a controller 200 and a database 260. The controller 220 may include a viewer confirmation part 230, a viewer request determining part 240 and a database inquiry part 250. The viewer confirmation part 230 can confirm the viewer's identification based on the identification number transmitted from the TV 100 before responding to the request transmitted from the server 200. The viewer request determining part 240 can determine whether information requested from the TV 100 is to store the viewer's environmental information or is to download the viewer's environmental information stored in the database 260 when the viewer's identification is confirmed through the viewer confirmation part 230. The database inquiry part 250 can inquire the viewer's environmental information corresponding to the ID number based on the viewer's ID number from the environmental information of the viewers stored in the database 260.

The database 260 can register personal information of a number of viewers and environmental information set by the viewers. Here, the personal information can be registered to the sever in such a manner that the viewers previously express the viewers' intention of registration to a company managing the server through mail, e-mail, visit or other ways.

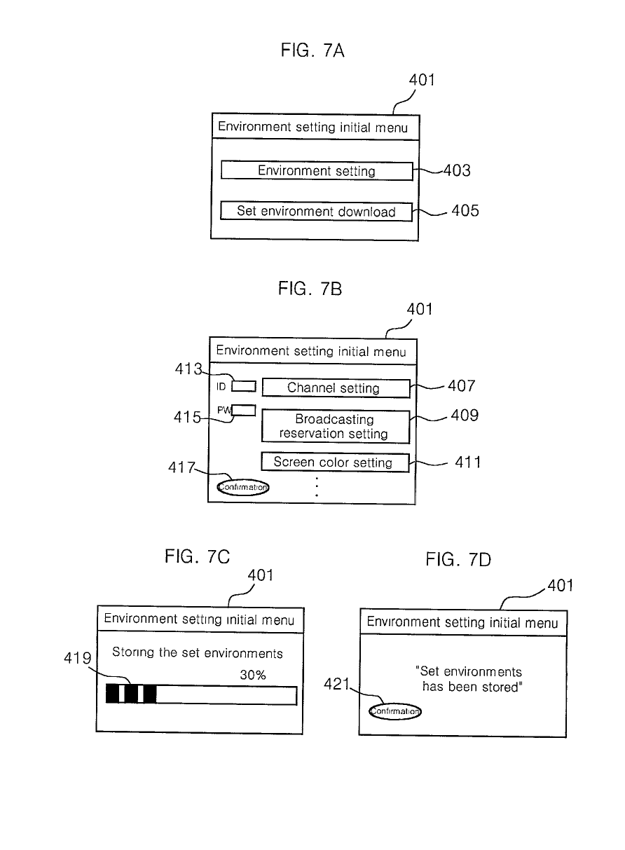

The operation of the digital TV system for setting viewer-environments using the network according to a preferred embodiment of the present invention will be described as follows. First, the controller 120 receiving the request of initial menu display of the viewer reads the initial menu from the memory 130 and outputs the same onto the screen through the display interface 140. When the viewer selects ‘environment setting’ (shown in FIG. 7a) from the initial menu, the TV 100 reads various lists for setting environments from the memory 130 and outputs the same through the display interface 140. When the viewer sets environments using the lists, the environmental information selected by the viewer is recognized by the controller 120 and transmitted and stored to the server 200 through the network.

Meanwhile, if the viewer watches broadcasting using the TV unsuitable for the viewer's taste, when the viewer requests the TV 100 to download the environmental information stored in the server 200, the TV 100 connects to the server 200 through the network and transmits the download request of environmental information. The server 200 inquires the environmental information stored in the database 260, reads the environmental information corresponding to the viewer's request and transmits the same to the TV 100.

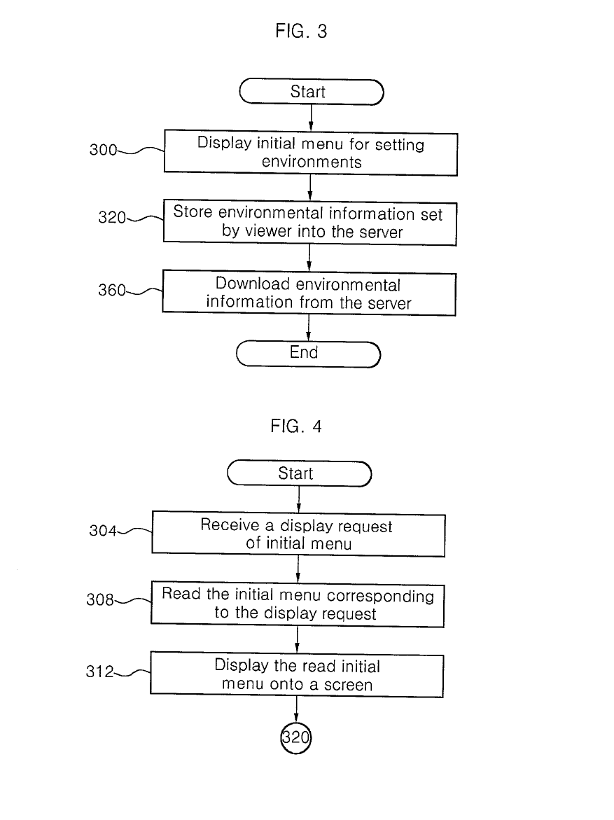

Referring to FIGS. 3 through 6, a control method of digital TV system for setting viewer-environments using the network will be described as follows.

FIG. 3 is a flow chart of the control method of digital TV system for setting viewer-environments using the network according to the preferred embodiment of the present invention.

Referring to FIG. 3, the initial menu for setting environments is displayed on the screen of the TV (Step 300). That is, as shown in FIG. 4, the viewer requests display of the initial menu to the controller through the viewer interface (Step 304). The controller of the TV responds to the display request of the initial menu and reads the initial menu from the memory (Step 308). Then, the controller outputs the read initial menu to the screen through the display interface (Step 312). As shown in FIG. 7a, the initial menu 401 includes an environment setting item 403 and a set environment download item 405. If wanting to set environments of the TV according to the viewer's taste, the viewer can select the environment setting item 403. Meanwhile, if wanting to download the environmental information stored in the server, the viewer can select the set environment download item 405.

For example, if the viewer selects the environment setting item 403 of the initial menu 401, as shown in FIG. 7b, the TV provides the viewer with various environment setting information for setting environments.

Referring to FIG. 7b, the screen for setting environments includes a channel selecting item 407, a broadcasting reservation setting item 409 and a screen color setting item 411. Further, the screen can include an UD number input window and a secret number input window for verifying identification of the viewer. Furthermore, the screen can further include a confirmation button 417 for notifying the viewer's environment setting to the TV. Here, the various environment setting information may be changed in various ways within the range of the present invention besides the method shown in FIG. 7b.

When the viewer sets environments suitable for the viewer's taste based on the initial menu and clicks the confirmation button after inputting the ID number and the secret number, the controller transmits the environmental information inputted by the viewer to the server through the network interface and through the network (Step 320). Here, the TV must previously know information provider (IP) address when transmitting the environmental information to the server. When the TV transmits the environmental information to the server, the environmental information includes TV address, server address, ID number and viewer selection environmental information. The server stores the environmental information into the database to correspond to the viewer's ID number. At this time, as shown in FIG. 7c, the controller provides the viewer with a state that the environmental information is stored in the server through the display interface. That is, referring to FIG. 7c, the controller indicates the environmental information storage state in percentage through a progress state bar 419 and allows the viewer to easily confirm a state that the environmental information is being stored in the server.

Moreover, as shown in FIG. 7d, if the environmental information is stored completely, the controller outputs character message of “set environment has been stored” on the screen through the display interface. When the viewer clicks the confirmation button 421, the controller moves to the initial menu.

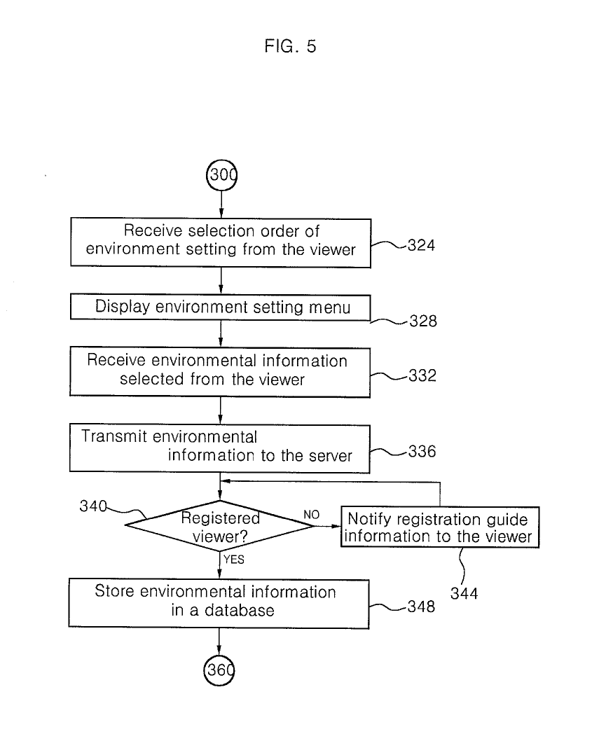

Referring to FIG. 5, the Step 320 will be described in more detail.

FIG. 5 illustrates a flow chart of a method for storing environmental information selected by a viewer, in the digital TV system for setting viewer-environments using the network according to the preferred embodiment.

Referring to FIG. 5, when the viewer selects the environment setting item using the initial menu, the TV receives environment setting order from the viewer through the interface and transmits the same to the controller (Step 324).

The controller reads the environment setting menu form the memory in response to the environment setting order and outputs the same on the screen through the display interface as shown in FIG. 7b (Step 328).

When the viewer selects environment setting suitable for the viewer's taste based on the environment setting menu (Step 332) the controller transmits the selected environmental information to the server through the network interface and through the network (Step 336).

The viewer confirmation part of the server confirms whether or not the viewer is registered based on the environmental information (Step 340).

If the viewer is not registered to the server, the server transmits registration guide information to the TV to display the same on the screen (Step 344).

If the viewer has been registered to the server, the server admits the viewer's connection and stores the environmental information to the database to correspond to the viewer's input if the viewer request determining part determines the received environmental information as information for storage (Step 348). In more detail, the database stores the environmental information to correspond to the ID number based on the viewer's ID number. Therefore, if the viewer requests download of the environmental information later, the environmental information can be read by inquiring the database based on the viewer's ID number.

Referring to FIG. 3, the TV receiving the download request of environmental information from the viewer connects to the server and downloads and executes the environmental information (Step 360).

At this time, in the TV, the environmental information suitable for the viewer's taste is not set. That is, the case corresponds to a case that many members of the family watch one TV, or a case that the viewer watches the TV in different place, e.g., in a friend's house or in a relative's house.

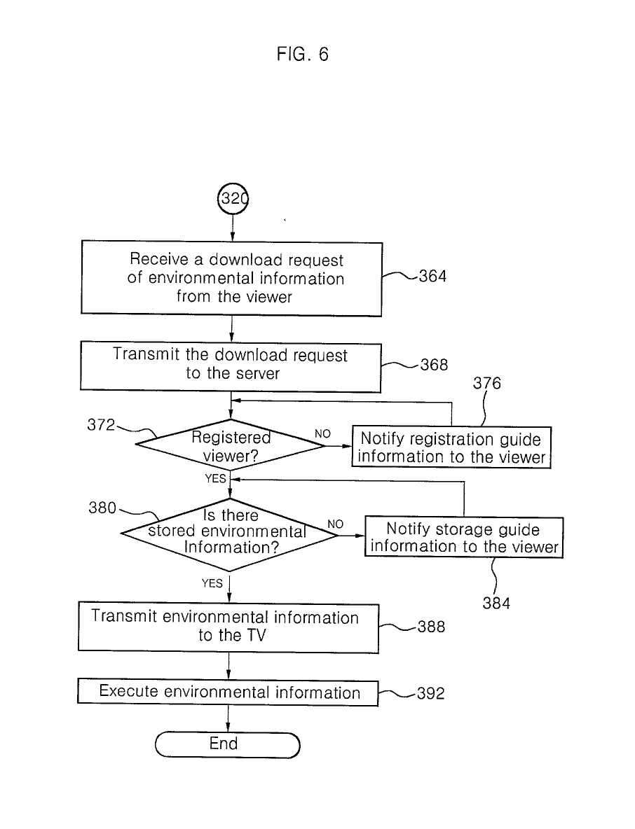

Here, referring to FIG. 6, the step 360 will be described in more detail.

FIG. 6 illustrates a flow chart of a method for setting TV environments using environmental information stored in a server, in the digital TV system for setting viewer-environments using the network according to the preferred embodiment.

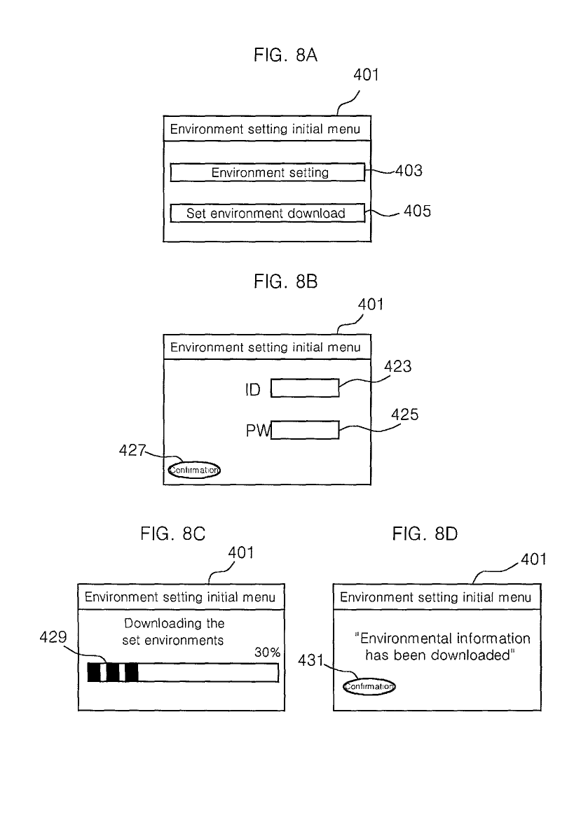

Referring FIG. 6, if the viewer wants to set environments of the TV into environments suitable for the viewer's taste, as shown in FIG. 8a, when the viewer selects the set environment download item 405 of the initial menu 401, the controller of the TV provides the viewer with the screen as shown in FIG. 8b. Then, if the viewer fills in an ID number input window 423 and a secret number input window 425 and clicks the confirmation button 427, the viewer's download request is transmitted to the controller through the viewer interface (Step 364).

The controller transmits the download request of environmental information to the server through the network (step 368). Here, if the download request is transmitted to the server, the environmental download request includes TV address, server address, ID number and download request code.

The viewer confirmation part of the server confirms whether the viewer is registered based on the ID number (Step 372). If the ID number is not registered, the viewer confirmation part outputs guide information on the screen through the TV (Step 376).

If the ID number is registered into the database, the viewer request determining part determines whether the request is the download request of environmental information based on the download request code or is the request of environmental information storage.

If the request is determined as the download request of environmental information, the database inquiry part inquires the database based on the ID number and confirms whether or not there is the stored environmental information (Step 380).

If there is not the stored environmental information, i.e., if the viewer does not store the environmental information to the server, the server outputs storage guide information on the screen through the TV (Step 384).

If there is the environmental information corresponding to the ID number by the database inquiry part, the environmental information is read and transmitted to the TV through the network based on the TV address (Step 388).

Then, the controller of the TV downloads the environmental information and displays a download progressive state through the display interface and through the progress state bar in percentage as shown in FIG. 8c. The environmental information outputs character message of “the environmental information has been downloaded” as shown in FIG. 8d when the environmental information is all downloaded.

If the environmental information is downloaded all, the controller executes the environment change program of the memory and changes the former environmental information into the viewer's environmental information (Step 392).

Meanwhile, the changed environmental information is separately stored in the memory. The TV may be set in the viewer's environmental information as it is if the viewer turns off the TV and turns on the TV again. Of course, if other viewer changes the environmental information again, the former viewer must download the environmental information from the server and set the TV environments.

According to another preferred embodiment of the present invention, if there are a plurality of servers for storing the environmental information, the viewer can search the server and download the environmental information from the server storing the viewer's environmental information. For this, the initial menu for setting environments may include additional server search menu or server list.

As described above, according to the digital TV system for setting viewer-environments using the network and the control method thereof, the TV environments may be always set into environments suitable for the viewer's taste by setting the TV environments through a simple manipulation by the viewer and storing into the server using the network.

According to the digital TV system for setting viewer-environments using the network and the control method thereof, the viewer can set the initial environments of any TV into environment suitable for the viewer's taste at any time if necessary and use the set environments stored in the server at any time by downloading the set environments stored in the server to the viewer's TV using the network and automatically setting the environments.

According to the digital TV system for setting viewer-environments using the network and the control method thereof, the environment set in the viewer's TV may be always maintained if other viewer changes the set environments.

The forgoing embodiments are merely exemplary and are not to be construed as limiting the present invention. The present teachings can be readily applied to other types of apparatuses. The description of the present invention is intended to be illustrative, and not to limit the scope of the claims. Many alternatives, modifications, and variations will be apparent to those skilled in the art.

What is claimed is:

1. A method for setting environment corresponding to a viewer's taste in a digital TV system including a TV connected with a server and a network, the method comprising the steps of:
transmitting environmental information selected by the viewer to the server using an initial menu from the TV to the server;
storing the environmental information into the server to correspond to the viewer's taste;
transmitting a download request of environmental information inputted by the viewer from the TV to the server;
transmitting the environmental information corresponding to the download request from the server to the TV; and
executing the environmental information downloaded from the TV.

2. The method according to claim 1, wherein in the step of transmitting the environmental information from the TV to the server, the environmental information includes TV address, server address, ID number and viewer selection environment information.

3. The method according to claim 1, wherein in the step of transmitting the download request of environmental information from the TV to the server, the download request includes TV address, server address, ID number and download request code.

4. The method according to claim 1, further comprising the step of outputting the initial menu in response to the viewer's request of environment setting from the TV before the step of transmitting to the server.

5. The method according to claim 1, further comprising the step of determining whether or not the viewer is registered based on the ID number included in the environmental information received from the TV.

6. The method according to claim 1, wherein the step of transmitting the environmental information from the server to the TV includes the steps of:
determining whether or not the viewer is registered based on the ID number included in the download request received from the TV; and
inquiring whether or not there is environmental information corresponding to the ID number.

7. The method according to claim 1, wherein the downloaded environmental information is changed into the viewer's environments through an environment change program.

8. A method for controlling a viewer's environment setting in a TV connected with a server and a network, the method comprising the steps of:
outputting initial menu in response to the viewer's request of environment setting;
transmitting a download request of environmental information inputted by the viewer to the server based on the initial menu;
receiving environmental information corresponding to the download request from the server; and
changing the former environments into environments suitable for the viewer's taste based on the downloaded environmental information, wherein the environmental information is inquired from the server based on the viewer's ID number.

9. The method according to claim 1, further comprising the step of transmitting the environmental information selected by the viewer using the initial menu before the step of transmitting the download request of environmental information to the server, wherein the environmental information is stored in the server corresponding to the viewer's ID number.

10. A method for providing a viewer's environments from a server connected with a TV and a network to the TV, the method comprising the steps of:
receiving environmental information selected by the viewer;
storing the environmental information corresponding to the viewer's ID number;
receiving a download request of environmental information inputted by the viewer from the TV;
inquiring whether or not there is the viewer's environmental information based on the ID number included in the download request;
reading the environmental information corresponding to the ID number when the viewer's environmental information is inquired; and
transmitting the read environmental information to the TV.

11. A digital TV system for setting a viewer's environments using a network, the system comprising:
a server for storing environmental information selected by the viewer, the server providing the environmental information when the viewer requests download;
a network for connecting to the server; and
a controller for transmitting the environmental information to the server, the controller transmitting the download request to the server when the viewer requests download of the environmental information, the controller executing the environmental information downloaded from the server and changing the former environments into environments suitable for the viewer's taste.

12. The digital TV system according to claim 11, further comprising a memory for storing a menu for setting environments, a program for executing the environmental information and the viewer's changed environments.

13. The digital TV system according to claim 12, wherein the memory includes at least one of an EEPROM, a flash ROM and an HDD.

14. The digital TV system according to claim 11, wherein the controller reads the initial menu from the memory for allowing the viewer to select the environmental information and provides onto a screen.

15. The digital TV system according to claim 11, wherein the server includes:
a viewer confirmation part for confirming whether or not the viewer is registered;
a viewer request determining part for determining the request received from the controller if the viewer is registered;
a database inquiry part for inquiring the viewer's environmental information based on the ID number if the request is the download request of environmental information; and
a database for storing the environmental information selected by the viewer to correspond to the ID number.

16. A digital TV device connected with a server and a network, the digital TV device comprising:
input means for inputting a viewer's environmental information;
display means for providing the viewer with initial menu for selecting the environmental information;
network connecting means for transmitting the environmental information to the server through the network and downloading the environmental information from the server;
storing means for storing the initial menu, environment change program and changed environmental information; and
controlling means for executing the environment change program and controlling for changing the former environments into the viewer's environments if the environmental information is input from the network connecting means through the network.

17. The device according to claim 16, wherein the controlling means reads the initial menu from the memory, outputs the same to the display means, receives the environmental information or a download request from the input means and controls to output the same to the network connecting means.

18. A server system comprising:
a memory for storing database and program; and
a processor connected to the memory and executing the program,
wherein the processor performs, by the program, the steps of:
receiving environmental information selected by a viewer;
storing the environmental information corresponding to the viewer's ID number;
receiving a download request of environmental information inputted by the viewer;
inquiring whether or not there is the viewer's environmental information based on the ID number included in the download request;
reading the environmental information corresponding to the ID number if the viewer's environmental information is inquired; and
transmitting the read environmental information to a TV.
